(19) United States
(12) Patent Application Publication
(10) Pub. No.: US 2012/0015948 A1
(43) Pub. Date: Jan. 19, 2012

(54) TABLET COMPOSITION

(76) Inventor: Ulick Stafford, County Wexford (IE)

(21) Appl. No.: 13/138,743

(22) PCT Filed: Mar. 31, 2010
(86) PCT No.: PCT/IE2010/000017

§ 371 Date: Sep. 23, 2011

Related U.S. Application Data
(60) Provisional application No. 61/202,737, filed on Mar. 31, 2009.

(51) Int. Cl. A01N 43/66; A01P 1/00

(52) U.S. Cl. 514/241

(57) ABSTRACT

A water soluble effervescent disinfecting tablet comprises a chlorinated isocyanurate such as anhydrous sodium dichloroisocyanurate. The tablet also comprises an alkali metal bicarbonate such as sodium bicarbonate, an aliphatic carboxyl acid such as adipidic acid, and a dessicant base such as sodium carbonate. The tablet contains a masking agent, especially isoamyl acetate and/or L-methone in an amount to mask taste and/or odour characteristics of the chlorinated isocyanurate.

The present invention relates to tablet compositions and in particular to a tablet composition which used to purify water to make it potable.

In many parts of the world there is no access to safe water supplies. This is especially so after natural disasters that can disrupt the water supply. In these circumstances it is possible to purify water at the point of use using a point of use water treatment. This may be either in tablet, powder or liquid form and is usually based on chlorine or possibly chlorine dioxide. Compositions that release free chlorine can impart a distinct odour and taste to the water that some users find objectionable. This smell and taste are particularly objectionable in areas of the world where there is no history of water chlorination.

Therefore, it is desirable to mask the odour and taste of the water purification composition. However, strong oxidising agents that make water safe by deactivating microbial water contaminant also oxidise many desirable odour masking agents. This may effect storage stability prior to use, efficacy of the purification agent if it is consumed by the masking compound and the effectiveness of the aroma compound.

### STATEMENTS OF INVENTION

According to the invention there is provided a water soluble effervescent disinfecting tablet comprising:
a chlorinated isocyanurate;
an alkali metal bicarbonate;
an aliphatic carboxylic acid;
a dessicant base; and
a compatible masking agent in an amount to mask taste and/or odour characteristics of the chlorinated isocyanurate.

In a particular embodiment of the invention the masking agent is selected from one or more of isoamyl acetate and L-menthone.

The masking agent may be present in an amount of at least 0.1% by weight of the tablet, at least 0.5% by weight of the tablet, from 0.5% to 2% by weight of the tablet, from 1% to 3% by weight of the tablet.

In one case the tablet comprises approximately 2% by weight of isoamyl acetate.

In another case the tablet comprises approximately 2% by weight of L-methone.

In one embodiment the chlorinated isocyanurate comprises sodium dicloroisocyanurate, particularly anhydrous sodium dichloroisocyanurate.

The chlorinated isocyanurate may be present in an amount of from 5% to 65% by weight of the tablet, from 15% to 55% by weight of the tablet, approximately 40% by weight of the tablet, approximately 35% by weight of the tablet, approximately 50% by weight of the tablet, from 15% to 20% by weight of the tablet.

In one embodiment the alkali metal bicarbonate comprises sodium bicarbonate. The alkali metal bicarbonate may be present in an amount of from 15% to 40% by weight of the tablet, from 15% to 35% by weight of the tablet, approximately 27% by weight of the tablet, approximately 22% by weight of the tablet, approximately 16% by weight of the tablet, approximately 40% by weight of the tablet.

In one embodiment the acid comprises adipic acid. The acid may be present in an amount of from 15% to 35% by weight of the tablet, from 20% to 35% by weight of the tablet, from 20% to 28% by weight of the tablet, approximately 28% by weight of the tablet, approximately 26% by weight of the tablet, approximately 23% by weight of the tablet, 22% by weight of the tablet.

In one embodiment the dessicant comprises an alkali metal carbonate. The alkali metal carbonate may comprise sodium carbonate. The alkali metal carbonate may be present in an amount of from 5% to 15% by weight of the tablet, from 3% to 10% by weight of the tablet, approximately 6% by weight of the tablet, approximately 10% by weight of the tablet, approximately 13% by weight of the tablet.

In one aspect the invention provides a water soluble effervescent disinfecting tablet comprising:
approximately 40% by weight of anhydrous sodium dichloroisocyanurate;
approximately 27% by weight of sodium bicarbonate;
approximately 26% by weight of adipic acid;
approximately 6% by weight of sodium carbonate; and
from 0.5% to 2% by weight of a masking agent selected from one or more of isoamyl acetate and L-menthone.

In another aspect the invention provides a water soluble effervescent disinfecting tablet comprising:
approximately 18% by weight of anhydrous sodium dichloroisocyanurate;
approximately 40% by weight of sodium bicarbonate;
approximately 27% by weight of adipic acid;
approximately 8% by weight of sodium carbonate; and
from 0.5% to 2% by weight of a masking agent selected from one or more of isoamyl acetate and L-menthone.

In a further aspect the invention provides a water soluble effervescent disinfecting tablet comprising:
approximately 35% by weight of anhydrous sodium dichloroisocyanurate;
approximately 32% by weight of sodium bicarbonate;
approximately 22% by weight of adipic acid;
approximately 10% by weight of sodium carbonate; and
from 0.5% to 2% by weight of a masking agent selected from one or more of isoamyl acetate and L-menthone.

In another aspect the invention provides a water soluble effervescent disinfecting tablet comprising:
approximately 20% by weight of anhydrous sodium dichloroisocyanurate;
approximately 40% by weight of sodium bicarbonate;
approximately 35% by weight of adipic acid;
approximately 6% by weight of sodium carbonate; and
from 0.5% to 2% by weight of a masking agent selected from one or more of isoamyl acetate and L-menthone.

In a further aspect the invention provides a water soluble effervescent disinfecting tablet comprising:
approximately 50% by weight of anhydrous sodium dichloroisocyanurate;
from 16% to 22% by weight of sodium bicarbonate;
approximately 23% by weight of adipic acid;
from 6% to 10% by weight of sodium carbonate; and
approximately 0.5% by weight of a masking agent selected from one or more of isoamyl acetate and L-menthone.

The invention also provides the use of the tablets of the invention for one or more of:
water disinfection;
disinfection of the inside of a container such as a bottle;
disinfection of a surface;

### DETAILED DESCRIPTION

The invention will be more clearly understood from the following description of some embodiments thereof, given by way of example only.

The invention relates to effervescent tablet compositions used to purify water to make it potable. The invention especially relates to the addition of a masking agent to a tablet composition to mask undesirable tastes and odours associated with treatment of drinking water.

In one embodiment effervescent sanitisation tablets with aroma masking can be used for sanitising applications where a more pleasant smell than chlorine is required.

In one example a tablet with an artificial herb smell is formulated for making a sterilisation solution for baby bottles. In another example an artificial herb flavour is added to an effervescent disinfection tablet for making up a hard surface sanitiser solution.

Disinfecting Agent

The disinfection agent is especially anhydrous sodium dichloroisocyanurate (NaDCC).

Effervescent Base

The chlorinated isocyanurate is blended with an alkali effervescent base. The effervescent base comprises an alkali metal bicarbonate. The effervescent base also comprises an aliphatic carboxylic acid such as adipic, fumaric or citric acid. The effervescent base also comprises a dessicant, especially an alkali metal carbonate, especially sodium carbonate.

The preferred alkali metal carbonate is sodium bicarbonate. The particular advantages of sodium bicarbonate are that it is very soluble in water, it is suitable for use in effervescent preparations and is readily available in pharmaceutical and food grades.

The aliphatic carboxylic acid is added to the preparation to react with the alkali metal bicarbonate and other carbonates liberating carbon dioxide bubbles thereby facilitating the effervescent disintegration of the tablet. Adipic acid is preferred as the aliphatic carboxylic acid. It has the advantage of being non-hygroscopic which helps preserve the integrity and stability of the finished formulation and when added to water slows the effervescent reaction down sufficiently that most chlorine liberated dissolves into the solution. It also has lubricating properties which aid the tabletting process.

Anhydrous sodium carbonate is preferred as the desiccant component. In addition to scavenging water in the tablet to bind it into stable sodium carbonate dihydrate molecules it also participates in the effervescent disintegration reaction to liberate carbon dioxide bubbles.

Masking Agents

We have found that many compounds that are widely used as aroma compounds are not suitable for use in tablet formulations of the invention as the tablets are not stable. Chlorine oxidises many aroma compounds. Incompatible materials include most alcohols, aldehydes and ethers. Many esters and ketones and other popular aroma compounds are incompatible. Materials that are potentially compatible include tertiary alcohols such as 3,7-dimethyl-3-octanol (rose), menthol, tertiary ethers such as eucolyptol(1,8-cineole), trans-anethole (liquorice), anisole, aliphatic esters such as isoamyl acetate (berry, banana odour), methyl acetate (mint, berry odour), undecanoic lactone (peach), aliphatic ketones such as L-menthone (mint), terpenes such as camphor, D-limonene, thymol, β-citronellol. It may also be particularly important to exclude water as much as possible from tablet and powder formulations. Another difficulty when making tablet or powder purification compositions is that many of the volatile odour masking agents are liquid at room temperature. It is also particularly important that the compound does not react with chlorine donors at any level that may cause off-flavours or reduce the effective dose of chlorine. The masking agents should also be approved for food use at their levels of use.

In the invention, taste and odour generated by water purification effervescent tablets is masked using a masking agent which does not detract from the activity of chlorine as a biocide. The masking agent provides a relatively strong aroma but without a strong aftertaste. The masking agent is added to provide sufficient taste and aroma without adding a noticeable flavour.

The masking agents are added at a level between 0.1% and 10% of the tablet or powder volume, more preferably between 0.5% and 2% which we have found is the highest concentration at which liquid aroma compounds can be easily blended into a powder. The amount of flavour imparted by the masking agent depends both on the strength of its aroma and on the size of the tablet to powder portion. The concentration of aroma compound in liquid formulations is limited by the solubility of the material.

We have found that materials that can potentially be used with sodium dichloroisocyanurate include tertiary alcohols such as 3,7-dimethyl-3-octanol (rose), menthol, tertiary ethers such as eucalyptol(1,8-cineole), aliphatic esters such as isoamyl acetate (fruit odour), methyl acetate (mint, berry odour) and undecanoic lactone (peach), aliphatic ketones such as L-menthone (mint) and camphor, some terpenes and terpenoids such as D-limonene (citrus), thymol, β-citronellol (citrus) and linalool (citrus), and other ethers such trans-anethole (liquorice) and anisole.

To verify the suitability of the material a compatibility test is carried out. In the compatibility test the aroma material is mixed in equal portions with the disinfectant material and the temperature rise of the material is measured. Because dry material may not react with incompatible materials in a short term test a small amount of water corresponding to 25% of the mixture weight is added to the mixture and well mixed. The maximum temperature rise is recorded. Because there may be some heat of solution when the disinfectant is dissolved in water, in a control a similar amount of water is added to the disinfectant material without the aroma compound and the temperature rise is measured. Ideally the difference of the temperature rise between the test and control should be no more than 10° C. and most preferably no more than 1° C.

Another difficulty when making a tablet purification composition is that many of the most suitable odour masking agents are liquid and hydrophobic at room temperature. During the blending stage these materials might form insoluble clumps with some of the tablet components. If they form a clump with the disinfectant or other important components such as those materials which make up the effervescent base the tablet dissolution might be slow. This made some additional materials unsuitable.

For water treatment the masking agent should add a relatively strong aroma without adding a strong aftertaste. Some further materials were found to be unsuitable for because they either did not add sufficient aroma to mask the smell, or added a strong after taste, or both.

Through extensive research and development we have found that isoamyl acetate and L-menthone are compatible with a tablet of chlorinated isocyanurate in an effervescent base. These agents are liquids in normal processing conditions. To simplify blending the liquid is first blended with one of the components until it is well mixed and the material flows well. The dessicant component is particulary suitable because of its capacity to absorb liquid and its lower volume than some of the other components in the blend. This material with aroma is blended with the other components prior to tabletting.

We have found that isoamyl acetate and L-menthone are compatible with the tablet composition. They are used at a low level—enough to mask the smell and taste of the composition, but not at such a high level to add another strong flavour to the water or cause manufacturing issues, or detract from the potency of chlorine as a biocide. The isoamyl acetate or L-menthone may be used at a high enough level to impart a significant flavour to the water. Amounts of up to 3% by weight can be added to tablets. The isoamyl acetate or L-menthone make the water more pleasant to drink.

In particular, we have surprisingly found that these agents may be added to the mixture used to produce a tablet. No other processing aid or carrier is required. It is all the more surprising that a significant amount (1% to 3% by weight) of these agents can be added to the tablet mix without adversely effecting the processing of the tablet and whilst still producing a highly stable tablet. Larger relative amounts can be added to smaller tablets with little difficulty. Larger tablets can only be made with lower amounts of aroma added.

The masking agents are added at a level between 1% and 3% of the tablet or powder volume, more preferably at about 2% which is the optimum concentration at which the agents can be easily blended into a powder.

### EXAMPLES

Drinking Water Disinfection Tablet Formulations

Chlorine disinfectant tablets for sanitising 20 L of water are made by blending iso-amyl acetate or L-menthone with anhydrous sodium carbonate and then blending with anhydrous sodium dichloroiscyanurate, sodium bicarbonate and adipic acid. All materials used are approved for use in potable drinking water, food or pharmaceuticals. All materials are powder grades suitable for making tablets. Tablets are made by compressing the mixture on a tablet press. To make 6.5 mm diameter, 67 mg NaDCC tablets (˜170 mg total weight) a force of 1-2 tonnes is used to make tablets with hardness in excess of 15 N breaking force with typical numbers in the range 25-50 N. Lesser force is used for smaller tablets and larger force for larger tablets and this force is adjusted by the tablet compression operator based on the quality of tablet made.

Water is purified by adding a tablet to a measured quantity of water. 3.5 mg NaDCC tablets are used to add 2 mg chlorine to a litre or water. 8.5 mg add 5 mg Cl per litre. 17 mg add 10 mg Cl per litre. 33 mg tablets are used to treat 10 L of water with 2 ppm Cl. 67 mg tablets treat 20 L with 2 ppm Cl and 167 mg tablet treat 20 L wtih 5 ppm Cl. Other tablet sizes and doses can be used.

### Examples 1-12

### Drinking Water Disinfection Tablet Formulations

| | | | Sodium | Adipic | Sodium | |
|---|---|---|---|---|---|---|
| No. | Diameter | NaDCC | Bicarbonate | acid | Carbonate | Aroma compound |
| 1 | 6.5 mm | 67 mg | 47.4 mg | 45.4 mg | 10.2 mg | 0.9 mg L-menthone |
| 2 | 6.5 mm | 67 mg | 47.4 mg | 45.4 mg | 10.2 mg | 1.7 mg L-menthone |
| 3 | 6.5 mm | 67 mg | 47.4 mg | 45.4 mg | 10.2 mg | 1.7 mg isoamyl acetate |
| 4 | 6.5 mm | 67 mg | 47.4 mg | 45.4 mg | 10.2 mg | 3.4 mg isoamyl acetate |
| 5 | 6.5 mm | 67 mg | 47.4 mg | 45.4 mg | 10.2 mg | 0.9 mg L-menthone, |
| | | | | | | 1.7 mg isoamyl acetate |
| 6 | 4.75 mm | 8.5 mg | 20.3 mg | 13.9 mg | 6.3 mg | 0.5 mg isoamyl acetate |
| 7 | 4.75 mm | 17 mg | 16 mg | 11 mg | 5 mg | 0.25 mg L-menthone, |
| | | | | | | 0.5 mg isoamyl acetate |
| 8 | 4.75 mm | 8.5 mg | 20 mg | 13.9 mg | 6.1 mg | 0.5 mg isoamyl acetate |
| 9 | 4.75 mm | 17 mg | 16 mg | 11 mg | 5 mg | 1 mg isoamyl acetate |
| 10 | 6.5 mm | 33 mg | 66.3 mg | 58.8 mg | 10.2 mg | 1.7 mg isoamyl acetate |
| 11 | 6.5 mm | 67 mg | 45.7 mg | 43.7 mg | 10.2 mg | 3.4 mg isoamyl acetate |
| 12 | 8.5 mm | 167 mg | 76.8 mg | 73.5 mg | 16.7 mg | 6.8 mg isoamyl acetate |

| | | | | | | Aroma |
|---|---|---|---|---|---|---|
| | Tablet | | Sodium | Adipic | Sodium | Com- |
| Ex. No. | Weight | NaDCC | Bicarbonate | acid | Carbonate | pound |
| 1 | 170.9 | 39.20% | 27.74% | 26.57% | 5.97% | 0.53% |
| 2 | 171.7 | 39.02% | 27.61% | 26.44% | 5.94% | 0.99% |
| 3 | 171.7 | 39.02% | 27.61% | 26.44% | 5.94% | 0.99% |
| 4 | 173.4 | 38.64% | 27.34% | 26.18% | 5.88% | 1.96% |
| 5 | 172.6 | 38.82% | 27.46% | 26.30% | 5.91% | 1.51% |
| 6 | 49.5 | 17.17% | 41.01% | 28.08% | 12.73% | 1.01% |
| 7 | 49.75 | 34.17% | 32.16% | 22.11% | 10.05% | 1.51% |
| 8 | 49 | 17.35% | 40.82% | 28.37% | 12.45% | 1.02% |
| 9 | 50 | 34.00% | 32.00% | 22.00% | 10.00% | 2.00% |
| 10 | 170 | 19.41% | 39.00% | 34.59% | 6.00% | 1.00% |
| 11 | 170 | 39.41% | 26.88% | 25.71% | 6.00% | 2.00% |
| 12 | 340.8 | 49.00% | 22.54% | 21.57% | 4.90% | 2.00% |

Example 1-5, 11 are ˜170 mg tablets with 67 mg NaDCC and different amounts of aroma compounds. Examples 6, 8 are 49 mg tablets with 8.5 mg of NaDCC and 0.5 g of iso-amyl acetate. Examples 7, 9 are 49 mg tablets with 17 mg of NaDCC and different amounts of aroma compounds. Because the 17 mg and 8.5 mg tablets are the same size the 17 mg tablets have twice the proportion of NaDCC and masking aroma as the 8.5 mg tablet with a lower proportion of the other materials. Similarly the 33 mg tablet, Example 10, is the same weight as some of the 67 mg examples but with half the amount of NaDCC and aroma compound. Example 12, a 167 mg tablet is the most concentrated example with 50% NaDCC.

Stability Studies

Tablets were strip packaged in paper aluminium-foil laminate and put into stability studies using ICH (International Conference on Harmonisation) recommended conditions for Accelerated Stability Studies (40° C. with 75% relative humidity).

Ref: ICH Harmonised Tripartite Guideline: Stability Testing of New Drug Substances and Products Q1A (R2)(2003).

| | Tablet intact and in excess |
|---|---|
| Example | of 90% Chlorine activity |
| Number | after 6 months |
| 1 | Yes |
| 2 | Yes |
| 3 | Yes |
| 5 | Yes |
| 8 | Yes |
| 9 | Yes |
| 10 | Yes |
| 11 | Yes |
| 12 | Yes |

Examples 1-3, 5, 8-12 with isoamyl acetate and/or L-menthone were intact and had in excess of 90% chlorine activity after 6 months on stability. The tablets of examples 4,6,7 were not tested for stability.

### Further Examples 13-20

### Drinking Water Disinfection Tablet Formulations

| | | | Sodium | | | |
|---|---|---|---|---|---|---|
| | | | Bicar- | Adipic | Sodium | Aroma |
| No. | Diameter | NaDCC | bonate | acid | Carbonate | compound |
| 13 | 6.5 mm | 67 mg | 47.4 mg | 45.4 mg | 10.2 mg | 1.7 mg D- |
| | | | | | | limonene |
| 14 | 6.5 mm | 67 mg | 47.4 mg | 45.4 mg | 10.2 mg | 0.9 mg D- |
| | | | | | | limonene |
| 15 | 6.5 mm | 67 mg | 47.4 mg | 45.4 mg | 10.2 mg | 1.7 mg β- |
| | | | | | | Citronellol |
| 16 | 4.75 mm | 3.5 mg | 22.8 mg | 15.6 mg | 7.1 mg | 0.1 mg D- |
| | | | | | | limonene |
| 17 | 4.75 mm | 33 mg | 11 mg | 7.6 mg | 3.4 mg | 0.9 mg |
| | | | | | | trans |
| | | | | | | anethole |
| 18 | 8.5 mm | 167 mg | 76.8 mg | 73.5 mg | 16.7 mg | 3.5 mg D- |
| | | | | | | limonene |

| | | | | | | Aroma |
|---|---|---|---|---|---|---|
| | Tablet | | Sodium | Adipic | Sodium | Com- |
| Ex. No. | Weight | NaDCC | Bicarbonate | acid | Carbonate | pound |
| 13 | 171.7 | 39.02% | 27.61% | 26.44% | 5.94% | 0.99% |
| 14 | 170.9 | 39.20% | 27.74% | 26.57% | 5.97% | 0.53% |
| 15 | 171.7 | 39.02% | 27.61% | 26.44% | 5.94% | 0.99% |
| 16 | 49.1 | 7.13% | 46.44% | 31.77% | 14.46% | 0.20% |
| 17 | 55.9 | 59.03% | 19.68% | 13.60% | 6.08% | 1.61% |
| 18 | 337.5 | 49.48% | 22.76% | 21.78% | 4.95% | 1.04% |

Stability Studies

Tablets were strip packaged in paper aluminium-foil laminate and put into stability studies using ICH (International conference on harmonisation) recommended conditions for Accelerated Stability Studies (40° C. with 75% relative humidity).

| | Tablet intact and in excess |
|---|---|
| Example | of 90% Chlorine activity |
| Number | after 6 months |
| 13 | No |
| 14 | No |
| 15 | No |
| 16 | No |
| 17 | No |
| 18 | No |

Examples 13-18 made with D-limonene, β-citronellol and trans anethole did not have in excess of 90% chlorine activity after 6 months accelerated stability study.

Tablets of Examples 13, 14, 16 and 18 with limonene formed clumps.

Tablets of Example 15 with citronellol did not sufficiently mask smell.

Tablets of Example 17 with trans-anethol imparted a strong aftertaste.

Tablets for Baby Bottle or Hard Surface Disinfection

Tablets for baby bottle disinfection or hard surface disinfection can be made using a similar formulation to the above but with a proportionately lower amount of aroma. The tablet is made by blending L-menthone or isoamyl acetate onto sodium carbonate and then blending with with NaDCC, sodium bicarbonate and adipic acid. The mixture is compressed into a 15.8 mm tablet using up to 10 tonnes force to make a tablet with hardness of minimum 15 N. This tablet can be used to make up a disinfection solution for baby bottle when diluted with 2 litres of water.

This tablet can also be used to make up a disinfecting solution for general disinfection of “non-sensitive” areas, such as walls, floors food-handling surfaces and trolleys, when diluted in 1.5 L of water, or for disinfection of “sensitive” areas, such as operating theatres, laboratories or post-mortem rooms, when 4 tablets are diluted in 1 L of water, or for disinfection of surfaces where there may be a risk of HIV or HBV infection when ˜17 tablets are diluted in 1 L of water, or disinfection of body fluid spillages when diluted at a rate of ˜35 tablets per 1 L of water.

### Examples 19-22

### Tablets for Baby Bottle or Hard Surface Disinfection

| | | | Sodium | Adipic | Sodium | |
|---|---|---|---|---|---|---|
| No. | Diameter | NaDCC | Bicarbonate | acid | Carbonate | Aroma compound |
| 19 | 15.8 mm | 500 mg | 214.9 mg | 220.1 mg | 60.0 mg | 5 mg isoamyl acetate |
| 20 | 15.8 mm | 500 mg | 214.9 mg | 220.1 mg | 60.0 mg | 5 mg L menthone |
| 21 | 15.8 mm | 500 mg | 160 mg | 235 mg | 100.0 mg | 5 mg isoamyl acetate |
| 22 | 15.8 mm | 500 mg | 160 mg | 235 mg | 100.0 mg | 5 mg L menthone |

| | | | | | | Aroma |
|---|---|---|---|---|---|---|
| | Tablet | | Sodium | Adipic | Sodium | Com- |
| Ex. No. | Weight | NaDCC | Bicarbonate | acid | Carbonate | pound |
| 19 | 1000 | 50.00% | 21.49% | 22.01% | 6.00% | 0.50% |
| 20 | 1000 | 50.00% | 21.49% | 22.01% | 6.00% | 0.50% |
| 21 | 1000 | 50.00% | 16.00% | 23.50% | 10.00% | 0.50% |
| 22 | 1000 | 50.00% | 16.00% | 23.50% | 10.00% | 0.50% |

The tablets of examples 19-20 have more sodium bicarbonate and less sodium carbonate than example 21-22. Stoichiometrically either formulation has the same amount of base relative to the adipic acid. The tablets of examples 21 and 22 compress marginally better but all formulations work well. This shows that the composition of base in the formula can be varied somewhat.

The invention is not limited to the embodiments hereinbefore described, which may be varied in detail.

1. A water soluble effervescent disinfecting tablet comprising:
a chlorinated isocyanurate;
an alkali metal bicarbonate;
an aliphatic carboxylic acid;
a dessicant base; and
a compatible masking agent in an amount to mask taste and/or odour characteristics of the chlorinated isocyanurate.

2. The tablet as claimed in claim 1 wherein the masking agent is selected from one or more of isoamyl acetate and L-menthone.

3. The tablet as claimed in claim 1 wherein the masking agent is present in an amount of at least 0.1% by weight of the tablet.

4. The tablet as claimed in claim 1 wherein the masking agent is present in an amount of at least 0.5% by weight of the tablet.

5. The tablet as claimed in claim 1 wherein the masking agent is present in an amount of from 0.5% to 2% by weight of the tablet.

6. The tablet as claimed in claim 1 wherein the masking agent is present in an amount of from 1% to 3% by weight of the tablet.

7. The tablet as claimed in claim 1 comprising approximately 2% by weight of isoamyl acetate.

8. The tablet as claimed in claim 1 comprising approximately 2% by weight of L-methone.

9. The tablet as claimed in claim 1 wherein the chlorinated isocyanurate comprises anhydrous sodium dichloroisocyanurate.

10. The tablet as claimed in claim 1 wherein the chlorinated isocyanurate is present in an amount of from 5% to 65% by weight of the tablet.

11. The tablet as claimed in claim 1 wherein the chlorinated isocyanurate is present in an amount of from 15% to 55% by weight of the tablet.

12. The tablet as claimed in claim 1 wherein the chlorinated isocyanurate is present in an amount of approximately 40% by weight of the tablet.

13. The tablet as claimed in claim 1 wherein the chlorinated isocyanurate is present in an amount of approximately 35% by weight of the tablet.

14. The tablet as claimed in claim 1 wherein the chlorinated isocyanurate is present in an amount of approximately 50% by weight of the tablet.

15. The tablet as claimed in claim 1 wherein the chlorinated isocyanurate is present in an amount of from 15% to 20% by weight of the tablet.

16. The tablet as claimed in claim 1 wherein the alkali metal bicarbonate comprises sodium bicarbonate.

17. The tablet as claimed in claim 1 wherein the alkali metal bicarbonate is present in an amount of from 15% to 40% by weight of the tablet.

18. The tablet as claimed in claim 1 wherein the alkali metal bicarbonate is present in an amount of from 15% to 35% by weight of the tablet.

19. The tablet as claimed in claim 1 wherein the alkali metal bicarbonate is present in an amount of approximately 27% by weight of the tablet.

20. The tablet as claimed in claim 1 wherein the alkali metal bicarbonate is present in an amount of approximately 22% by weight of the tablet.

21. The tablet as claimed in claim 1 wherein the alkali metal bicarbonate is present in an amount of approximately 16% by weight of the tablet.

22. The tablet as claimed in claim 1 wherein the alkali metal bicarbonate is present in an amount of approximately 40% by weight of the tablet.

23. The tablet as claimed in claim 1 wherein the acid comprises adipic acid.

24. The tablet as claimed in claim 1 wherein the acid is present in an amount of from 15% to 35% by weight of the tablet.

25. The tablet as claimed in claim 1 wherein the acid is present in an amount of from 20% to 35% by weight of the tablet.

26. The tablet as claimed in claim 1 wherein the acid is present in an amount of from 20% to 28% by weight of the tablet.

27. The tablet as claimed in claim 1 wherein the acid is present in an amount of approximately 28% by weight of the tablet.

28. The tablet as claimed in claim 1 wherein the acid is present in an amount of approximately 26% by weight of the tablet.

29. The tablet as claimed in claim 1 wherein the acid is present in an amount of approximately 23% by weight of the tablet.

30. The tablet as claimed in claim 1 wherein the acid is present in an amount of approximately 22% by weight of the tablet.

31. The tablet as claimed in claim 1 wherein the dessicant comprises an alkali metal carbonate.

32. The tablet as claimed in claim 31 wherein the alkali metal carbonate comprises sodium carbonate.

33. The tablet as claimed in claim 1 wherein the alkali metal carbonate is present in an amount of from 5% to 15% by weight of the tablet.

34. The tablet as claimed in claim 1 wherein the alkali metal carbonate is present in an amount of from 3% to 10% by weight of the tablet.

35. The tablet as claimed in claim 1 wherein the alkali metal carbonate is present in an amount of approximately 6% by weight of the tablet.

36. The tablet as claimed in claim 1 wherein the alkali metal carbonate is present in an amount of approximately 10% by weight of the tablet.

37. The tablet as claimed in claim 1 wherein the alkali metal carbonate is present in an amount of approximately 13% by weight of the tablet.

38. (canceled)

39. (canceled)

40. (canceled)
